(19) United States
(12) Patent Application Publication
(10) Pub. No.: US 2008/0229115 A1
(43) Pub. Date: Sep. 18, 2008

(54) PROVISION OF FUNCTIONALITY VIA OBFUSCATED SOFTWARE

(75) Inventors: Matthias Hermann Wollnik, Seattle, WA (US); Nir Ben-Zvi, Redmond, WA (US); Aaron Goldsmid, Seattle, WA (US); Hakki Tunc Bostanci, Redmond, WA (US); Karan Singh Dhillon, Renton, WA (US); Nathan Jeffrey Ide, Bothell, WA (US); John Richard McDowell, Seattle, WA (US); David John Linsley, Seattle, WA (US)

Correspondence Address: WOODCOCK WASHBURN LLP (MICROSOFT CORPORATION), CIRA CENTRE, 12TH FLOOR, 2929 ARCH STREET, PHILADELPHIA, PA, 19104-2891, US

(73) Assignee: Microsoft Corporation, Redmond, WA (US)

(21) Appl. No.: 11/687,252

(22) Filed: Mar. 16, 2007

(51) Int. Cl. H04L 9/32

(52) U.S. Cl. 713/190

(57) ABSTRACT

In an example embodiment, executable files are individually encrypted utilizing a symmetric cryptographic key. For each user to be given access to the obfuscated file, the symmetric cryptographic key is encrypted utilizing a public key of a respective public/private key pair. A different public key/private key pair is utilized for each user. Obfuscated files are formed comprising the encrypted executable files and a respective encrypted symmetric cryptographic key. The private keys of the public/private key pairs are stored on respective smart cards. The smart cards are distributed to the users. When a user wants to invoke the functionality of an obfuscated file, the user provides the private key via his/her smart card. The private key is retrieved and is utilized to decrypt the appropriate portion of the obfuscated file. The symmetric cryptographic key obtained therefrom is utilized to decrypt the encrypted executable file.

### TECHNICAL FIELD

The technical field relates generally to computer processing and more specifically to obfuscation of software functionality.

### BACKGROUND

It is not uncommon for a software developer to utilize a third party, or parties, to help develop software and update existing software. It also is not uncommon for the software developer to desire that the software be protected from reverse engineering, hacking, or the like. A dilemma however, is how to protect the software while allowing third parties access to the software.

### SUMMARY

This Summary is provided to introduce a selection of concepts in a simplified form that are further described below in the Detailed Description Of Illustrative Embodiments. This Summary is not intended to identify key features or essential features of the claimed subject matter, nor is it intended to be used to limit the scope of the claimed subject matter.

Functionality of, and access to, software is selectively controlled. An executable file is generated such that functions of the file can be selectively executed. In an example embodiment, portions of the file corresponding to specific functions are protected by respective cryptographic techniques. Users can access the file and execute selected functions of the file in accordance with the cryptographic techniques. To invoke functionality, a user can provide an authentication token, cryptographic key, or the like, via a storage device, such as a smart card.

### BRIEF DESCRIPTION OF THE DRAWINGS

The foregoing summary, as well as the following detailed description, is better understood when read in conjunction with the appended drawings. For the purpose of illustrating the provision of functionality via obfuscated software, there is shown in the drawings exemplary constructions thereof, however, providing functionality via obfuscated software is not limited to the specific methods and instrumentalities disclosed.

FIG. 1 is an example functional illustration depicting the generation of, and access to, obfuscated software.

FIG. 2 is a flow diagram of an example process for generating obfuscated software.

FIG. 3 is a flow diagram of an example process for invoking the functionality of obfuscated software.

FIG. 4 is a diagram of an exemplary processor for generating and/or executing obfuscated software.

FIG. 5 is a depiction of an example suitable computing environment in which the provision of functionality via obfuscated software can be implemented.

### DETAILED DESCRIPTION OF ILLUSTRATIVE EMBODIMENTS

Functions provided by a software file (e.g., executable file) can be selectively executed via cryptographic techniques. In an example embodiment, software pertaining to specific functionality is encrypted utilizing a cryptographic key. The encrypted software forms an obfuscated executable portion of an obfuscated binary file. The executable portion can contain data as well as executable code. The obfuscated executable portion can contain multiple encrypted portions, each being encrypted with the same cryptographic key (or with various combinations of cryptographic keys), and each, upon decryption, capable of providing a respective functionality. The obfuscated executable portion also can contain non-obfuscated portions that can successfully be executed without utilizing a cryptographic key. The cryptographic key and other information are combined and encrypted utilizing a public key of a public/private cryptographic key pair. The encrypted combination and the obfuscated executable portion form an obfuscated binary file. In an example embodiment, the obfuscated binary file is stored for subsequent access. The obfuscated binary file can be stored in any appropriate storage means, such as semiconductor memory, magnetic disk, optical memory, flash memory, or the like, for example. The private key of the cryptographic key pair is stored on an external device, such as a smart card or the like. Multiple, different, public key/private key pairs can be utilized for multiple users. When a user wants to invoke the obfuscated functionality portion of the binary file, the user provides the private key to the processor via the storage device. The private key is retrieved and is utilized to decrypt the appropriate portion of the obfuscated binary file. The cryptographic key obtained therefrom is utilized to decrypt the encrypted portion, or portions, of the obfuscated executable. In various embodiments, multiple cryptographic keys can be utilized, for example, to further encrypt cryptographic keys.

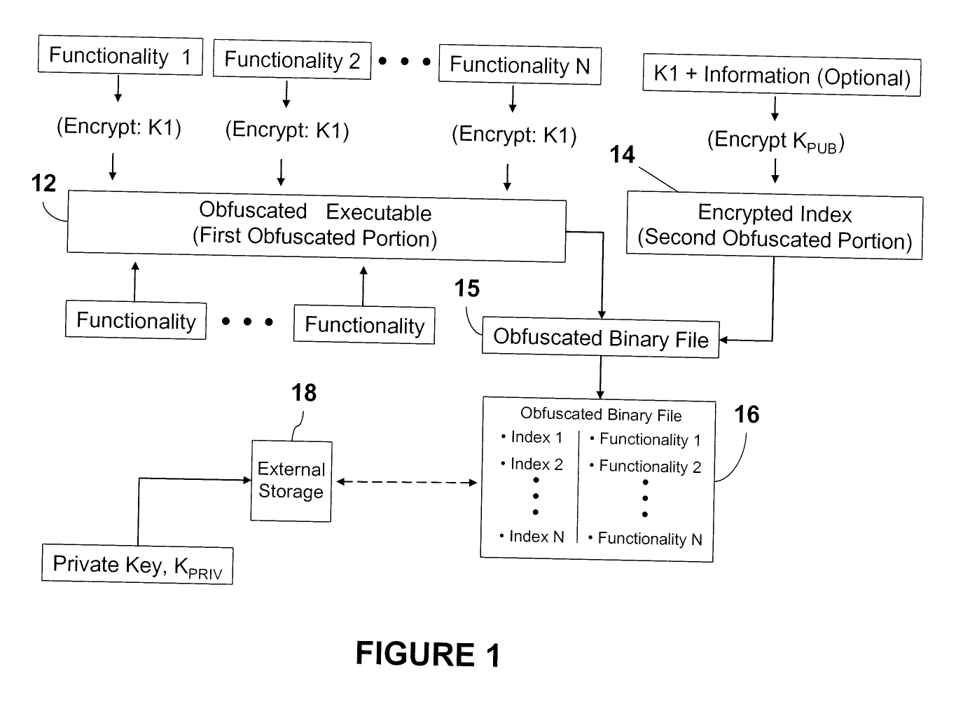

FIG. 1 is an example functional illustration depicting the generation of, and access to, obfuscated software. Each of functionality 1 through functionality N represents software capable of providing respective functionality. Each functionality can represent a stand alone executable file. For example, each functionality may contain software that can perform a function designed specifically for a user (e.g., an authentication mechanism); each functionality can contain a function designed specifically for a particular hardware specification, each functionality can contain an individualized cryptographic algorithm; each functionality can contain SKU differentiators such as standard, deluxe, premier; each functionality can contain activation or authorization code, such as used in digital rights management; or the like. A functionality can be an implementation of a new algorithm that is being developed and shared between a restricted group of persons, wherein several persons have access to the executable file and do not have access to the new algorithm. To generate an obfuscated executable portion 12, each software functionality is encrypted. This can be accomplished in any appropriate manner. In an example embodiment, each functionality is encrypted utilizing a cryptographic key, denoted as K1 in FIG. 1. The cryptographic key can comprise any appropriate key. In an example embodiment, the cryptographic key comprises a symmetric cryptographic key, such as a cryptographic key in accordance with the Advanced Encryption Standard (e.g., AES 256), for example. In various embodiments, the software functionalities can be encrypted utilizing symmetric cryptographic techniques, asymmetric cryptographic techniques, public key cryptographic techniques, obfuscated using non-cryptographic techniques, or a combination thereof. The encrypted functionalities are incorporated into the obfuscated executable portion 12. Thus, the obfuscated executable portion 12 comprises encrypted software that can not execute properly until decrypted. The value N represents any appropriate number of software functionalities. The obfuscated executable portion 12 need not necessarily comprise multiple encrypted software functionalities. Any number of functionalities can be incorporated into the obfuscated executable portion. For example, a single software functionality can be encrypted and incorporated into the obfuscated executable portion 12. In various example embodiments, other numbers of cryptographic keys are utilized. For example, all software functionalities (e.g., functionalities 1-N) can be encrypted using the same cryptographic key (e.g., K1), each software functionality can be encrypted using different cryptographic key, or a combination thereof.

As explained in more detail below, the cryptographic key, K1, can optionally be combined with information relating to the software functionality, or functionalities, and the combination is encrypted with a public key of a public/private key pair to generate the encrypted index 14. The encrypted index 14 and the obfuscated executable portion 12 are combined to form the obfuscated binary file 15. Also, as illustrated in FIG. 1, the obfuscated executable portion 15 also can contain non-obfuscated portions that can successfully be executed without utilizing a cryptographic key. Thus, the encrypted binary file 15 includes a first obfuscated portion comprising the obfuscated executable portion 12 and a second obfuscated portion comprising the encrypted index 14. The obfuscated binary file 15 is stored for subsequent access in entity 16. In an example embodiment, each obfuscated file stored in the entity 16 comprises at least one encrypted functionality and, respectively, at least one associated encrypted index. Entity 16 can represent any appropriate entity, such as a processor, a storage device, or a combination thereof, for example. The private key of the public/private key pair is stored on an external storage device 18. The external storage device 18 is external with respect to the entity 16. The external storage device 18 can comprise any appropriate device capable of storing the private key, such as a smart card, a processor, a disk, a flash memory, a PDA, or the like, for example.

When a user wants to invoke the functionality of a software functionality, or functionalities, in the obfuscated executable file stored in the entity 16, the user provides the private key on the external storage device 18. The entity 16 on which the obfuscated executable file is stored will decrypt the encrypted index utilizing the private key provided by the external storage device 18. The cryptographic key (e.g., K1) obtained from the decrypted index is used to decrypt the encrypted software functionality. The decrypted functionality is then available for execution.

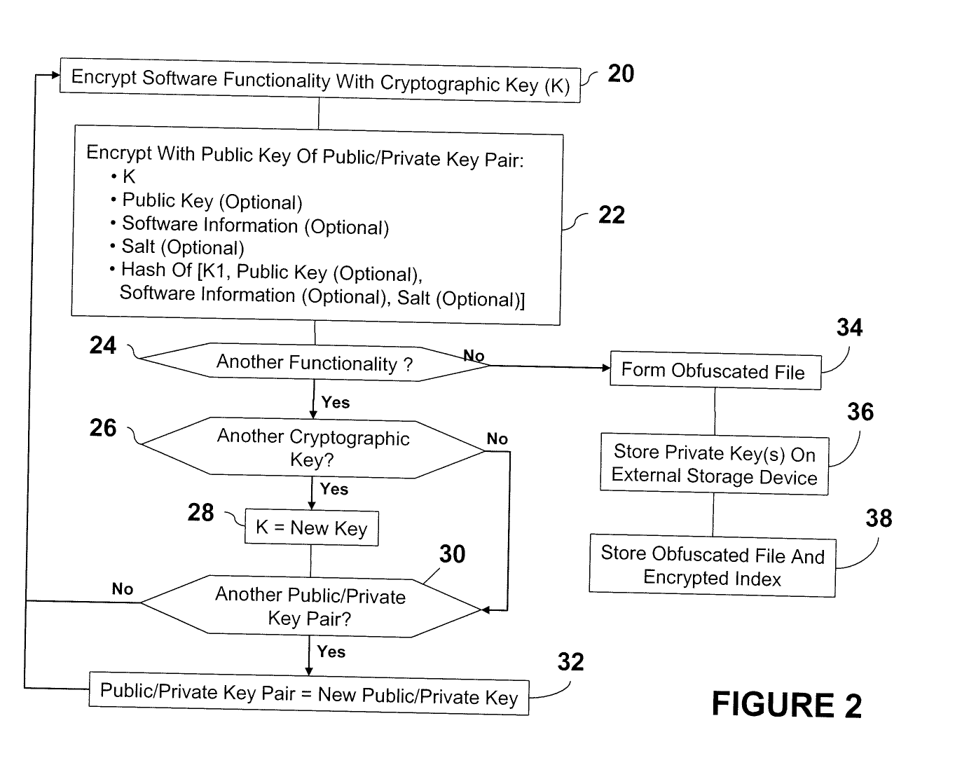

FIG. 2 is a flow diagram of an example process for generating obfuscated software. At step 20, software is encrypted with a cryptographic key, K. The software can be any appropriate software, such that upon decryption, the software is executable. The cryptographic, K, as described above can comprise any appropriate key, such as a symmetric cryptographic key, for example. The cryptographic key, K, is encrypted at step 22. In an example embodiment, as described above, the cryptographic key, K, is encrypted utilizing a public key of a public/private key pair. Public key cryptography (e.g., RSA public key cryptography), which utilizes a public/private key pair, is known in the art. One key is used to encrypt and the other is used to decrypt. Knowledge of one key does not provide knowledge of the other key. Typically one key is kept secret, and thus called the private key. The other key typically is made public.

Optionally, additional information can be encrypted utilizing the public key, at step 22. The additional information can include the public key, information pertaining to the software functionality (e.g., name of functionality, author of functionality, functionality size), salt (a random number of predetermined length), a hash value indicative of the data being encrypted with the public key, or a combination thereof. A hash value of the data is the result of operating on the data with a hash function. Hash functions are known in the art. A hash function is a function that transforms a variable-size input into a fixed size value. Typically, hash functions are one way, meaning that it is impracticable or impossible to determine the input value from the output (transformed) value. Providing the same input to a hash function will provide the same output. A slight change in the input typically results in a considerable change in the output. Thus, at step 22, the cryptographic key can be combined with the optional, additional information, and the combination is encrypted to form an encrypted index utilizing the public key of a public/private key pair.

At step 24, it is determined if more software functionalities are to be encrypted. If another software functionality is to be encrypted (step 24), it is determined at step 26 if another cryptographic key is to be utilized to encrypt the software functionality. If another cryptographic key is to be utilized to encrypt the next software functionality, the current cryptographic key, K, is replaced with the new cryptographic key at step 28. At step 30, it is determined if another public/private key pair is to be utilized to encrypt the cryptographic key, K, and optional additional information. If another public/private key pair is to be utilized to encrypt the cryptographic key, K, and optional additional information, the current public/private key pair is replaced with the new public/private key pair at step 32. The process proceeds to step 20 and continues as described above. If, at step 26, it is determined that another cryptographic key, K, is not to be utilized, but rather, the current cryptographic key, K, is to be utilized, the process proceeds directly to step 30, skipping step 28. If, at step 30, it is determined that another public/private key pair is not to be utilized, but rather, the current public/private key pair is to be utilized, the process proceeds directly to step 20.

If, at step 24, it is determined that there are no more software functionalities to be encrypted, an obfuscated file is formed at step 34. As described above, the obfuscated file comprises the encrypted software functionality, or functionalities, generated at step 20, and the encrypted cryptographic key, K, and any additional optional information, generated at step 22. At step 36, the private key, or keys, of the respective public key, or keys, are stored on an external storage device, such as a smart card or the like. At step 38, the obfuscated file is stored on a processor, a storage device, or the like.

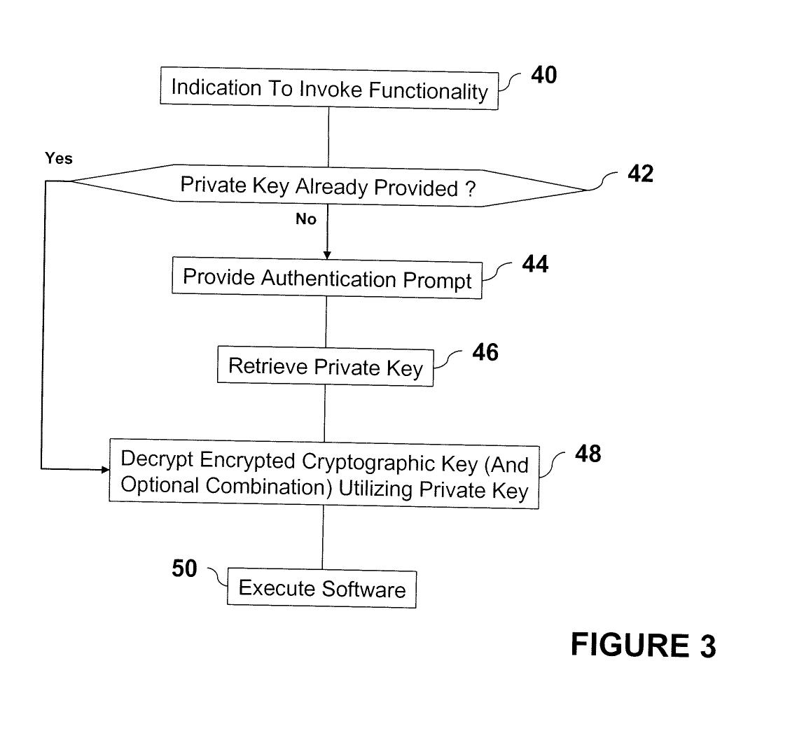

FIG. 3 is a flow diagram of an example process for invoking the functionality of obfuscated software. Generally, to execute an encrypted software functionality to invoke its functionality, the cryptographic key (e.g., symmetric cryptographic key) utilized to encrypt the software functionality is obtained by utilizing the private key of a public/private key pair to decrypt the appropriate portion of the obfuscated file. The cryptographic key is then utilized to decrypt the encrypted software functionality, and the decrypted software functionality is executed.

An indication to invoke functionality occurs at step 40. This could occur at runtime, for example, when an application or user wants to execute an encrypted functionality to invoke its functionality. It is determined, at step 42 if the private key corresponding to the public key of the public/private key pair, needed to decrypt the obfuscated file has been provided. If the public key has not been provide (step 42), an authentication prompt is provided at step 44. The authentication prompt can comprise any appropriated means for requesting the private key, such as a prompt rendered on a display instructing a user to insert a smart card, for example. At step 46, the private key is retrieved, e.g., via insertion of a smart card into the processor hosting the obfuscated software. The user could, at this point, optionally fulfill an authorization requirement, such as entering a password or the like, to allow access to the external storage device.

The private key is utilized to decrypt the appropriate portion of the obfuscated file at step 48. In an example embodiment, the appropriate portion comprises the public-key-encrypted cryptographic key (e.g., cryptographic key, K, in FIG. 2). In other example embodiments, the appropriate portion of the obfuscated file can contain a public-key-encrypted combination of the cryptographic key and additional optional information such as the public key, information pertaining to the software whose functionality is being invoked, a salt, a hash value, or a combination thereof. In an example embodiment, if more than one obfuscated file is stored on the processor or the like, an ID can be associated with each obfuscated file, thus indicating which obfuscated file is to be decrypted with the private key. In another example embodiment, hash values can be used to determine if the appropriate obfuscated file has been decrypted. For example, when the public-key-encrypted portion of the obfuscated file is decrypted using the retrieved private key, a hash value for the resulting decrypted data can be calculated. If calculated hash value matches the decrypted hash value, the correct obfuscated file has been decrypted, and the cryptographic key obtained therefrom is used to decrypt the desired software functionality(s). If the hash values do not match, the next obfuscated file is decrypted with the retrieved private key and hash values are calculated and compared. This can continue until a match occurs. Upon successful decryption of the encrypted software functionality, the software functionality is executed at step 50.

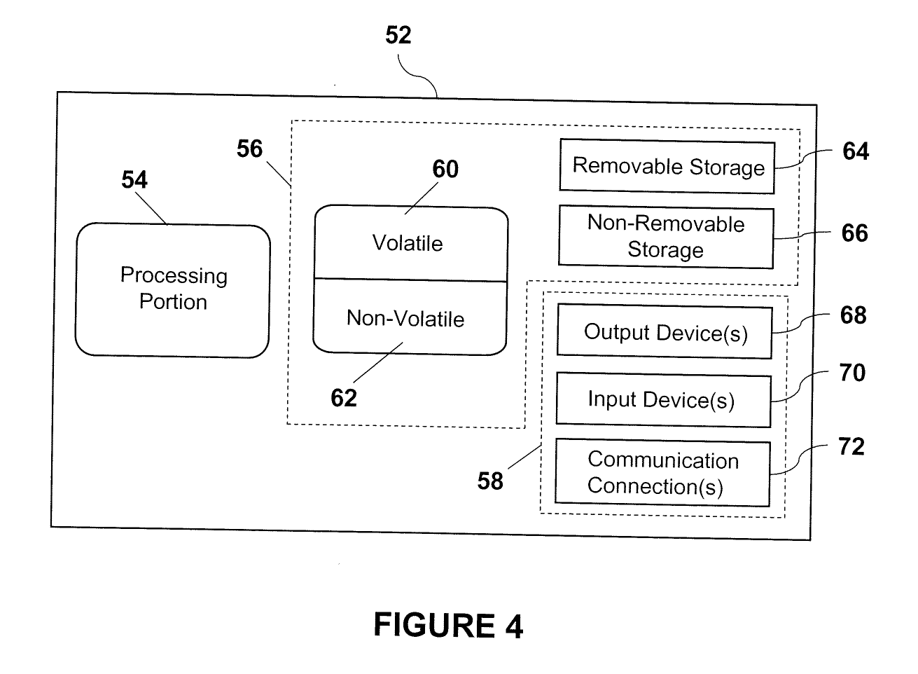

FIG. 4 is a diagram of an exemplary processor 52 for generating and/or executing obfuscated software. The processor 52 comprises a processing portion 54, a memory portion 56, and an input/output portion 58. The processing portion 54, memory portion 56, and input/output portion 58 are coupled together (coupling not shown in FIG. 4) to allow communications therebetween. The input/output portion 58 is capable of providing and/or receiving components utilized to generate and/or execute obfuscated software as described above.

The processing portion 54 is capable of generating and/or executing obfuscated software as described above. For example, the processing portion 54 is capable of defining and encrypting a software functionality with a cryptographic key, encrypting a cryptographic key with a public key, encrypting a public key with a public key, encrypting information related to a software functionality with a public key, encrypting salt with a public key, encrypting a hash value with a public key, calculating a hash value, decrypting an encrypted cryptographic key with a private key, decrypting an encrypted private key with a private key, decrypting encrypted information related to a software functionality with a private key, decrypting an encrypted salt with a private key, decrypting an encrypted hash value with a private key, determining if another software functionality is to be encrypted, determining if another cryptographic key is to be used to encrypt a software functionality, replacing a current cryptographic key with a new cryptographic key, determining if another public/private key pair is to be utilized, replacing a current public/private key pair with a new public/private key pair, comparing hash values, retrieving a private key, generating an authentication prompt, and executing a decrypted software functionality.

The processor 52 can be implemented as a client processor and/or a server processor. In a basic configuration, the processor 52 can include at least one processing portion 54 and memory portion 56. The memory portion 56 can store any information utilized in conjunction with generating and/or executing obfuscated software. Depending upon the exact configuration and type of processor, the memory portion 56 can be volatile (such as RAM) 60, non-volatile (such as ROM, flash memory, etc.) 62, or a combination thereof. The processor 52 can have additional features/functionality. For example, the processor 52 can include additional storage (removable storage 64 and/or non-removable storage 66) including, but not limited to, magnetic or optical disks, tape, flash, smart cards or a combination thereof. Computer storage media, such as memory portion 56, 60, 62, 64, and 66, include volatile and nonvolatile, removable and non-removable media implemented in any method or technology for storage of information such as computer readable instructions, data structures, program modules, or other data. Computer storage media include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, universal serial bus (USB) compatible memory, smart cards, or any other medium which can be used to store the desired information and which can be accessed by the processor 52. Any such computer storage media can be part of the processor 52.

The processor 52 can also contain communications connection(s) 72 that allow the processor 52 to communicate with other devices, for example. Communications connection(s) 72 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. The term computer readable media as used herein includes both storage media and communication media. The processor 52 also can have input device(s) 70 such as keyboard, mouse, pen, voice input device, touch input device, etc. Output device(s) 68 such as a display, speakers, printer, etc. also can be included.

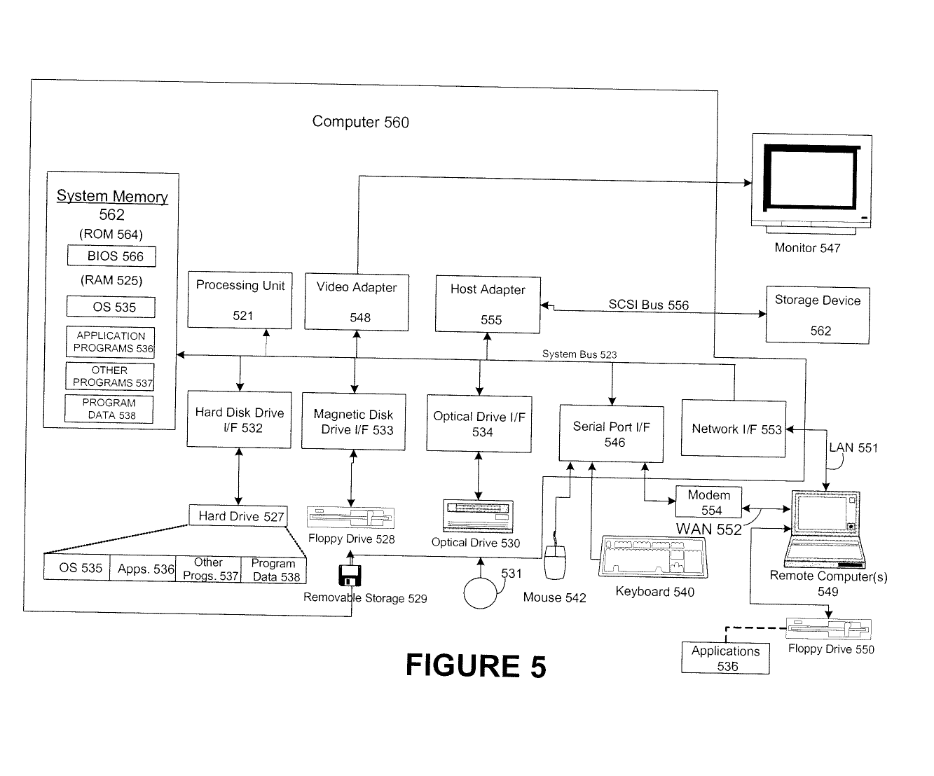

FIG. 5 and the following discussion provide a brief general description of an example suitable computing environment in which the provision of functionality via obfuscated software can be implemented. Although not required, various aspects of providing functionality via obfuscated software can be described in the general context of computer executable instructions, such as program modules, being executed by a computer, such as a client workstation or a server. Generally, program modules include routines, programs, objects, components, data structures and the like that perform particular tasks or implement particular abstract data types. Moreover, implementation of the provision of functionality via obfuscated software can be practiced with other computer system configurations, including hand held devices, multi processor systems, microprocessor based or programmable consumer electronics, network PCs, minicomputers, mainframe computers, and the like. Further, the provision of functionality via obfuscated software also can be practiced in distributed computing environments where tasks are performed by remote processing devices that are linked through a communications network. In a distributed computing environment, program modules can be located in both local and remote memory storage devices.

A computer system can be roughly divided into three component groups: the hardware component, the hardware/software interface system component, and the applications programs component (also referred to as the “user component” or “software component”). In various embodiments of a computer system the hardware component may comprise the central processing unit (CPU) 521, the memory (both ROM 564 and RAM 525), the basic input/output system (BIOS) 566, and various input/output (I/O) devices such as a keyboard 540, a mouse 542, a monitor 547, and/or a printer (not shown), among other things. The hardware component comprises the basic physical infrastructure for the computer system.

The applications programs component comprises various software programs including but not limited to compilers, database systems, word processors, business programs, videogames, and so forth. Application programs provide the means by which computer resources are utilized to solve problems, provide solutions, and process data for various users (machines, other computer systems, and/or end-users). In an example embodiment, application programs perform the functions associated with generating and/or executing obfuscated software as described above.

The hardware/software interface system component comprises (and, in some embodiments, may solely consist of) an operating system that itself comprises, in most cases, a shell and a kernel. An “operating system” (OS) is a special program that acts as an intermediary between application programs and computer hardware. The hardware/software interface system component may also comprise a virtual machine manager (VMM), a Common Language Runtime (CLR) or its functional equivalent, a Java Virtual Machine (JVM) or its functional equivalent, or other such software components in the place of or in addition to the operating system in a computer system. A purpose of a hardware/software interface system is to provide an environment in which a user can execute application programs.

The hardware/software interface system is generally loaded into a computer system at startup and thereafter manages all of the application programs in the computer system. The application programs interact with the hardware/software interface system by requesting services via an application program interface (API). Some application programs enable end-users to interact with the hardware/software interface system via a user interface such as a command language or a graphical user interface (GUI).

A hardware/software interface system traditionally performs a variety of services for applications. In a multitasking hardware/software interface system where multiple programs may be running at the same time, the hardware/software interface system determines which applications should run in what order and how much time should be allowed for each application before switching to another application for a turn. The hardware/software interface system also manages the sharing of internal memory among multiple applications, and handles input and output to and from attached hardware devices such as hard disks, printers, and dial-up ports. The hardware/software interface system also sends messages to each application (and, in certain case, to the end-user) regarding the status of operations and any errors that may have occurred. The hardware/software interface system can also offload the management of batch jobs (e.g., printing) so that the initiating application is freed from this work and can resume other processing and/or operations. On computers that can provide parallel processing, a hardware/software interface system also manages dividing a program so that it runs on more than one processor at a time.

A hardware/software interface system shell (referred to as a “shell”) is an interactive end-user interface to a hardware/software interface system. (A shell may also be referred to as a “command interpreter” or, in an operating system, as an “operating system shell”). A shell is the outer layer of a hardware/software interface system that is directly accessible by application programs and/or end-users. In contrast to a shell, a kernel is a hardware/software interface system's innermost layer that interacts directly with the hardware components.

As shown in FIG. 5, an exemplary general purpose computing system includes a conventional computing device 560 or the like, including a processing unit 521, a system memory 562, and a system bus 523 that couples various system components including the system memory to the processing unit 521. The system bus 523 may be any of several types of bus structures including a memory bus or memory controller, a peripheral bus, and a local bus using any of a variety of bus architectures. The system memory includes read only memory (ROM) 564 and random access memory (RAM) 525. A basic input/output system 566 (BIOS), containing basic routines that help to transfer information between elements within the computing device 560, such as during start up, is stored in ROM 564. The computing device 560 may further include a hard disk drive 527 for reading from and writing to a hard disk (hard disk not shown), a magnetic disk drive 528 (e.g., floppy drive) for reading from or writing to a removable magnetic disk 529 (e.g., floppy disk, removal storage), and an optical disk drive 530 for reading from or writing to a removable optical disk 531 such as a CD ROM or other optical media. The hard disk drive 527, magnetic disk drive 528, and optical disk drive 530 are connected to the system bus 523 by a hard disk drive interface 532, a magnetic disk drive interface 533, and an optical drive interface 534, respectively. The drives and their associated computer readable media provide non volatile storage of computer readable instructions, data structures, program modules and other data for the computing device 560. Although the exemplary environment described herein employs a hard disk, a removable magnetic disk 529, and a removable optical disk 531, it should be appreciated by those skilled in the art that other types of computer readable media which can store data that is accessible by a computer, such as magnetic cassettes, flash memory cards, digital video disks, Bernoulli cartridges, random access memories (RAMs), read only memories (ROMs), and the like may also be used in the exemplary operating environment. Likewise, the exemplary environment may also include many types of monitoring devices such as heat sensors and security or fire alarm systems, and other sources of information.

A number of program modules can be stored on the hard disk, magnetic disk 529, optical disk 531, ROM 564, or RAM 525, including an operating system 535, one or more application programs 536, other program modules 537, and program data 538. A user may enter commands and information into the computing device 560 through input devices such as a keyboard 540 and pointing device 542 (e.g., mouse). Other input devices (not shown) may include a microphone, joystick, game pad, satellite disk, scanner, or the like. These and other input devices are often connected to the processing unit 521 through a serial port interface 546 that is coupled to the system bus, but may be connected by other interfaces, such as a parallel port, game port, or universal serial bus (USB). A monitor 547 or other type of display device is also connected to the system bus 523 via an interface, such as a video adapter 548. In addition to the monitor 547, computing devices typically include other peripheral output devices (not shown), such as speakers and printers. The exemplary environment of FIG. 5 also includes a host adapter 555, Small Computer System Interface (SCSI) bus 556, and an external storage device 562 connected to the SCSI bus 556.

The computing device 560 may operate in a networked environment using logical connections to one or more remote computers, such as a remote computer 549. The remote computer 549 may be another computing device (e.g., personal computer), a server, a router, a network PC, a peer device, or other common network node, and typically includes many or all of the elements described above relative to the computing device 560, although only a memory storage device 550 (floppy drive) has been illustrated in FIG. 5. The logical connections depicted in FIG. 5 include a local area network (LAN) 551 and a wide area network (WAN) 552. Such networking environments are commonplace in offices, enterprise wide computer networks, intranets and the Internet.

When used in a LAN networking environment, the computing device 560 is connected to the LAN 551 through a network interface or adapter 553. When used in a WAN networking environment, the computing device 560 can include a modem 554 or other means for establishing communications over the wide area network 552, such as the Internet. The modem 554, which may be internal or external, is connected to the system bus 523 via the serial port interface 546. In a networked environment, program modules depicted relative to the computing device 560, or portions thereof, may be stored in the remote memory storage device. It will be appreciated that the network connections shown are exemplary and other means of establishing a communications link between the computers may be used.

While it is envisioned that numerous embodiments of the provision of functionality via obfuscated software are particularly well-suited for computerized systems, nothing in this document is intended to limit the invention to such embodiments. On the contrary, as used herein the term “computer system” is intended to encompass any and all devices capable of storing and processing information and/or capable of using the stored information to control the behavior or execution of the device itself, regardless of whether such devices are electronic, mechanical, logical, or virtual in nature.

The various techniques described herein can be implemented in connection with hardware or software or, where appropriate, with a combination of both. Thus, the methods and apparatuses for implementing the provision of functionality via obfuscated software, or certain aspects or portions thereof, can take the form of program code (i.e., instructions) embodied in tangible media, such as floppy diskettes, CD-ROMs, hard drives, or any other machine-readable storage medium, wherein, when the program code is loaded into and executed by a machine, such as a computer, the machine becomes an apparatus for providing functionality via obfuscated software.

The program(s) can be implemented in assembly or machine language, if desired. In any case, the language can be a compiled or interpreted language, and combined with hardware implementations. The methods and apparatuses for implementing the provision of functionality via obfuscated software also can be practiced via communications embodied in the form of program code that is transmitted over some transmission medium, such as over electrical wiring or cabling, through fiber optics, or via any other form of transmission, wherein, when the program code is received and loaded into and executed by a machine, such as an EPROM, a gate array, a programmable logic device (PLD), a client computer, or the like. When implemented on a general-purpose processor, the program code combines with the processor to provide a unique apparatus that operates to invoke the functionality of the provision of functionality via obfuscated software. Additionally, any storage techniques used in connection with the provision of functionality via obfuscated software can invariably be a combination of hardware and software.

While providing functionality via obfuscated software has been described in connection with the example embodiments of the various figures, it is to be understood that other similar embodiments can be used or modifications and additions can be made to the described embodiments for performing the same functions of providing functionality via obfuscated software without deviating therefrom. Therefore, the provision of functionality via obfuscated software as described herein should not be limited to any single embodiment, but rather should be construed in breadth and scope in accordance with the appended claims.

What is claimed:

1. A software obfuscation method comprising:
encrypting a software portion, wherein:
the software portion is encrypted utilizing a cryptographic key; and
the software portion is executable;
generating a first obfuscated portion comprising the encrypted software portion;
encrypting the cryptographic key, wherein:
the cryptographic key is encrypted utilizing a public key of a public/private cryptographic key pair comprising the public key and a private key;
generating a second obfuscated portion comprising the encrypted cryptographic key;
generating an obfuscated file comprising the first obfuscated portion and the second obfuscated portion; and
storing the obfuscated file.

2. A method in accordance with claim 1, further comprising storing the private key on a storage device.

3. A method in accordance with claim 2, wherein the obfuscated file is stored on a processor, the method further comprising:
retrieving, by the processor from the storage device, the private key;
decrypting the second obfuscated portion utilizing the retrieved private key;
obtaining a decrypted cryptographic key from the decrypted second obfuscated portion; and
decrypting the encrypted software portion utilizing the obtained, decrypted cryptographic key.

4. A method in accordance with claim 2, wherein the storage device comprises a smart card.

5. A method in accordance with claim 1, wherein the cryptographic key comprises a symmetric cryptographic key.

6. A method in accordance with claim 1, wherein:
the first obfuscated portion further comprises a plurality of software portions;
each of the plurality of software portions is encrypted utilizing the cryptographic key; and
each of the plurality of software portions is executable.

7. A method in accordance with claim 1, further comprising:
encrypting the cryptographic key a plurality of times to generate the second obfuscated portion, wherein:
the cryptographic key is encrypted a plurality of times utilizing a respective public key of a respective plurality of public/private cryptographic key pairs comprising respectively, a plurality of public keys and a plurality of private keys; and
storing the plurality of private keys on a respective plurality of storage devices, such that each one of the plurality of storage devices contains at least one private key of the plurality of public/private cryptographic key pairs stored thereon.

8. A method in accordance with claim 1, wherein:
a plurality of software portions is encrypted to form the first obfuscated portion;
each of the plurality of software portions is encrypted utilizing a respective cryptographic key of a respective plurality of cryptographic keys;
each of the plurality of software portions is executable; and
the second obfuscated portion comprises each one of the plurality of cryptographic keys encrypted utilizing the public key.

9. A method in accordance with claim 1, wherein:
a plurality of software portions is encrypted to form the first obfuscated portion;
each of the plurality of software portions is encrypted utilizing a respective cryptographic key of a respective plurality of cryptographic keys;
each of the plurality of software portions is executable;
the second obfuscated portion comprises each of the plurality of cryptographic keys encrypted utilizing a respective public key of a respective plurality of public/private cryptographic key pairs comprising respectively, a plurality of public keys and a plurality of private keys; and
each of the plurality of private keys is stored on a respective plurality of storage devices, such that each one of the plurality of storage devices contains at least one private key of the plurality of public/private cryptographic key pairs stored thereon.

10. A method in accordance with claim 1, wherein:
the second obfuscated portion further comprises at least one of a hash value, a salt, information pertaining to the software portion, the public key; and
the at least one of the hash value, the salt, the information pertaining to the software portion, the public key is encrypted utilizing the public key.

11. A software obfuscation system comprising:
a processing portion configured to:
encrypt a software portion, wherein:
the software portion is encrypted utilizing a cryptographic key; and
the software portion is executable;
generate a first obfuscated portion comprising the encrypted software portion;
encrypt the cryptographic key, wherein:
the cryptographic key is encrypted utilizing a public key of a public/private cryptographic key pair comprising the public key and a private key;
generate a second obfuscated portion comprising the encrypted cryptographic key; and
generate an obfuscated file comprising the first obfuscated portion and the second obfuscated portion; and
a first memory portion configured to store the obfuscated file; and
a second memory portion configured to store the private key.

12. A system in accordance with claim 11, wherein the second memory portion comprises a smart card.

13. A system in accordance with claim 11, wherein the cryptographic key comprises a symmetric cryptographic key.

14. A system in accordance with claim 11, wherein:
the first obfuscated portion further comprises a plurality of software portions;
each of the plurality of software portions is encrypted utilizing the cryptographic key; and
each of the plurality of software portions is executable.

15. A system in accordance with claim 11, wherein the processing portion is further configured to:
encrypt the cryptographic key a plurality of times to generate the second obfuscated portion, wherein the cryptographic key is encrypted a plurality of times utilizing a respective public key of a respective plurality of public/private cryptographic key pairs comprising respectively, a plurality of public keys and a plurality of private keys; and
store the plurality of private keys on a respective plurality of storage devices, such that each one of the plurality of storage devices contains a single private key stored thereon.

16. A system in accordance with claim 11, the processing portion further configured to encrypt a plurality of software portions to form the first obfuscated portion, wherein:
each of the plurality of software portions is encrypted utilizing a respective cryptographic key of a respective plurality of cryptographic keys;
each of the plurality of software portions is executable; and
the second obfuscated portion comprises each one of the plurality of cryptographic keys encrypted utilizing the public key.

17. A system in accordance with claim 11, the processing portion further configured to encrypt a plurality of software portions to form the first obfuscated portion, wherein:
each of the plurality of software portions is encrypted utilizing a respective cryptographic key of a respective plurality of cryptographic keys;
each of the plurality of software portions is executable;
the second obfuscated portion comprises each of the plurality of cryptographic keys encrypted utilizing a respective public key of a respective plurality of public/private cryptographic key pairs comprising respectively, a plurality of public keys and a plurality of private keys; and
each of the plurality of private keys is stored on a respective plurality of storage devices, such that each one of the plurality of storage devices contains at least one private key of the plurality of public/private cryptographic key pairs stored thereon.

18. A system in accordance with claim 11, wherein:
the second obfuscated portion further comprises at least one of a hash value, a salt, information pertaining to the software portion, the public key; and
the at least one of the hash value, the salt, the information pertaining to the software portion, the public key is encrypted utilizing the public key.

19. A computer-readable medium having stored thereon computer-executable instruction for software obfuscation by performing the steps of:
encrypting a software portion, wherein:
the software portion is encrypted utilizing a cryptographic key; and
the software portion is executable;
generating a first obfuscated portion comprising the encrypted software portion;
encrypting the cryptographic key, wherein:
the cryptographic key is encrypted utilizing a public key of a public/private cryptographic key pair comprising the public key and a private key;
generating a second obfuscated portion comprising the encrypted cryptographic key;
generating an obfuscated file comprising the first obfuscated portion and the second obfuscated portion; and
storing the private key on a storage device.

20. A computer-readable medium in accordance with claim 19, the computer-executable instructions further for:
retrieving the private key;
decrypting the second obfuscated portion utilizing the retrieved private key;
obtaining a decrypted cryptographic key from the decrypted second obfuscated portion; and
decrypting the encrypted software portion utilizing the obtained, decrypted cryptographic key.
